(19) United States
(12) Patent Application Publication
(10) Pub. No.: US 2014/0379706 A1
(43) Pub. Date: Dec. 25, 2014

(54) Content Management System with Chained Document Discovery

(71) Applicant: Geoffrey Neil Peters, Vancouver (CA)

(72) Inventor: Geoffrey Neil Peters, Vancouver (CA)

(73) Assignee: SAP AG, Walldorf (DE)

(21) Appl. No.: 13/926,889

(22) Filed: Jun. 25, 2013

(51) Int. Cl. G06F 17/30

(52) U.S. Cl. CPC G06F 17/30011; G06F 17/3053
USPC 707/725

(57) ABSTRACT

Data is received by a content management system that identifies a first document managed by the content management system. Thereafter, the first document is associated with a first user that authored or edited the first document. Subsequently, the first user is associated with at least one chained document different from the first document that has at least one pre-defined attribute associated with the first user. Data can then be provided that characterizes the at least one chained document. Related apparatus, systems, techniques and articles are also described.

### TECHNICAL FIELD

The subject matter described herein relates to a content management system with chained document discovery techniques.

### BACKGROUND

Users are generating increasingly large numbers of documents. As a result, enterprises are increasingly adopting content management systems in order to allow users to identify, access, and traverse documents indexed by the content management system. However, as the number of documents increases, so does the difficulty in identifying, discovering, and recommending relevant documents within a very large corpus of documents.

### SUMMARY

In one aspect, data is received by a content management system that identifies a first document managed by the content management system. Thereafter, the first document is associated with a first user that authored or edited the first document. Subsequently, the first user is associated with at least one chained document different from the first document that has at least one pre-defined attribute associated with the first user. Data can then be provided (e.g., displayed, stored, loaded into memory, transmitted to a remote server/node, etc.). that characterizes the at least one chained document.

The at least one first attribute can be the first user having indicated as being a favorite document. In addition or in the alternative, the at least one first attribute can be one or more of: the first user accessed the chained document, the first user edited the chained document, and the first user generated the first document.

There can be a plurality of chained documents and, in such cases, the chained documents can be presented to a user according to a ranking. Various ranking methodologies can be used including: a time at which each document was indicated as being a favorite document for the first user, a time at which each document was generated, a time at which each document was last accessed, a number of times that each document was accessed, and/or a time at which each document was last edited.

In some cases, additional filters can be performed on the at least one chained document (especially in cases in which there are a large number of documents). For example, a user can specify at least one keyword or other search filter (word stemming, an applied tag, a term extracted from within the document, etc.) and such keywords/search filter can be used to find responsive documents within the plurality of chained documents (and such documents could be displayed to the user).

Various access controls can be implemented such that a user is either not provided access to chained documents for which he or she does not have appropriate access levels or such documents are simply omitted from the results.

The content management system can include at least one data processor and memory for storing instructions for execution by the at least one data processor.

Computer program products are also described that comprise non-transitory computer readable media storing instructions, which when executed one or more data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter allows for enhanced usability for traversing documents indexed by a content management system. Furthermore, users can rely on their peers or others that they trust to identify documents that might be of particular interest.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system architecture diagram illustrating an environment including a content management system;

FIG. 2 is a diagram illustrating chained documents; and

FIG. 3 is a process flow diagram illustrating a method for traversing chained documents within a content management system.

Like reference symbols in the various drawings indicate like elements.

### DETAILED DESCRIPTION

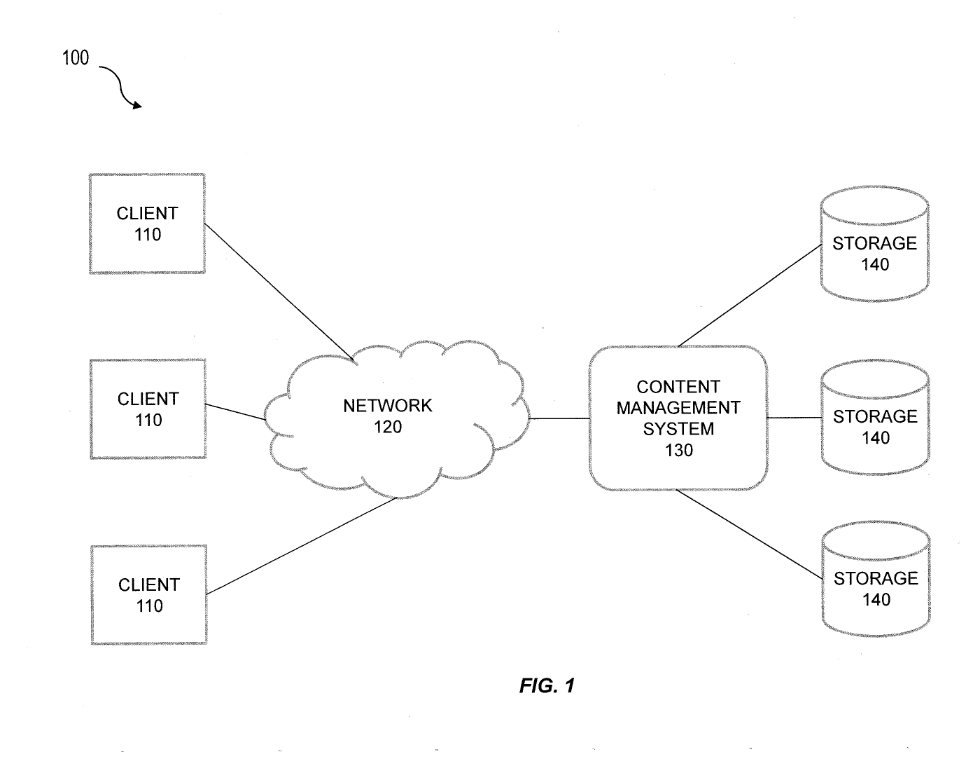

FIG. 1 is a diagram 100 illustrating an architecture for implementing the current subject matter in which a plurality of clients 110 (e.g., desktops, mobile phones, tablet computers, etc.) access a content management system 130 via a network (for example, via web services, etc.). The content management system 130 is, in turn, coupled to a plurality of data sources 140 which can be directly coupled or accessible via a computer network such as the Internet. The content management system 130 can comprise hardware (e.g., at least one processor coupled to memory) and/or software that allows for publishing, editing and modifying content in the data sources 140. Example software implementations of the content management system 130 include SHAREPOINT and DESKSITE. The content management system 130 can provide a unified interface to allow users to search, traverse, and otherwise access documents within the data sources 140. The content management system 130 can be used to generate and/or search metadata associated with documents and additionally the contents of the documents. In some variations, the content management system 130 can assign an identification (ID) to each document.

The content management system 130 can allow chaining of documents to enable traversal/searching based on attributes of other users. In one example, the attribute can be pre-defined and based on whether the user indicated a particular document as being a favorite. This can be done, for example, via a graphical user interface in which the user selects a graphical user interface element (e.g., a star, etc.) to classify a document as being one of his or her favorite documents. Alternatively, the user can mark the document as a favorite, move it or link it to a favorites folder, or otherwise indicate a preference for the document. The time the preference is indicated can be recorded as an attribute. Other attributes can also be used such as last documents accessed by a user, last documents edited by a user, last documents created by a user, time of document generation, time(s) of access, number of accesses, and the like. In other variations, the pre-defined attributes can be based on a level of similarity among different documents. For example, a number of matching keywords or other aspects can be used to identify those documents that are most similar to a currently viewed/accessed/selected document. These and/or other attributes can be used to associate a particular document with a particular user in order to allow for the traversal of chained documents as described herein.

Attributes as used herein (for chaining and filtering) can also arise from the document content itself. For example, attributes can comprise or be based on words or data obtained from the body of the document. Furthermore, attributes can be derived from intelligent/automated analysis of the document content (such as through computer vision or other tools for identifying “features” from a document, or even a screenshot/thumbnail of the document). The attributes can also comprise or be based on associated user-provided “metadata” for the document (such as user-entered keywords, titles, summaries, abstracts that are intended to be used as a guide to document discovery).

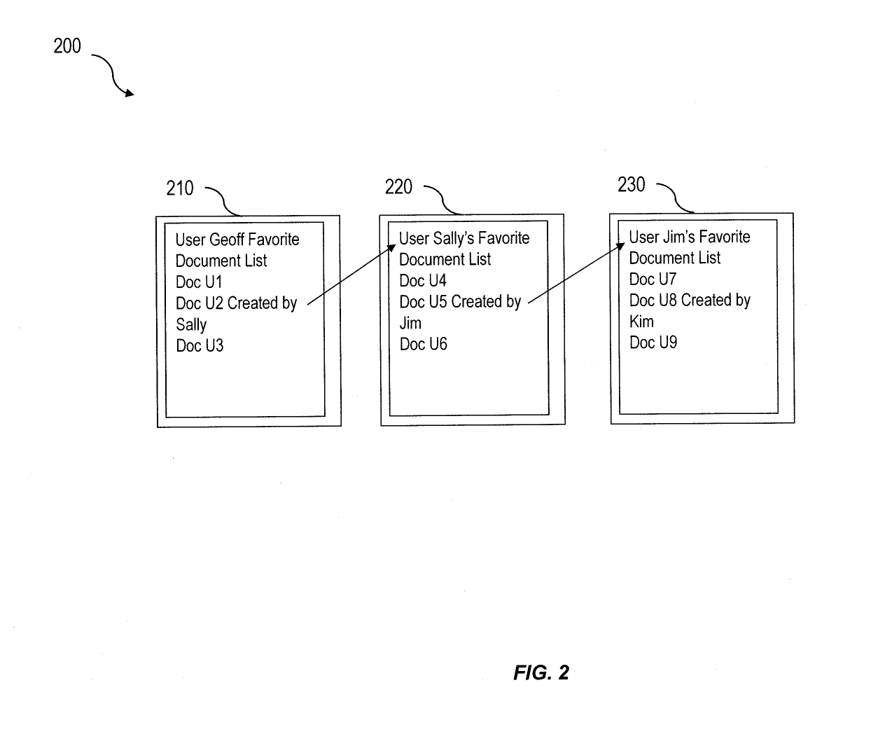

For any user, to discover documents which might be interesting to them, for a given document D (which may be in the user's favorites), the content management system 130 can suggest that the user examines the “favorite” documents of the person who created document D. This process can be repeated by the content management system 130 on the next set of identified documents, essentially following these “favorite chains” as an aid to discovery of documents. For example, with reference to the diagram 200 of FIG. 2, a user accesses a first document created by a user Geoff. A first view 210 can show the favorite list of documents associated with Geoff. The user can select one of these documents (for example, using a graphical user interface element in the first view 210), document U2, which was created by Sally. Thereafter, a second view 220 can be displayed that shows the favorite documents of Sally. The user can then select a graphical user interface element associated with a document U5 that was created by a user Jim. In response, a third view 230 can be displayed that shows the favorite documents of Jim.

Documents that are discovered in this fashion can be displayed in an interactive way (that can be different than the representation of diagram 200 of FIG. 2), to allow the user to explore the document chains in their own, self-directed fashion. For example, a view can be redrawn to show more documents either added to the bottom or top of a list, as the user clicks on documents to follow the favorite chains. The chained documents can be listed or otherwise displayed as part of an interface of a content management system.

In other cases, a specialized interface can be presented within a document viewing and editing application such as a word processing application, a presentation generation application, a spreadsheet application and the like. In such cases, some or all of the chained documents can be displayed via, for example, a drop down menu, a graphical user interface element/box, or the like (e.g., a button for next chained document, etc.). In other cases, the chained documents can be traversed/explored using a web browser or similar arrangement.

Certain attributes about each document (whether pre-existing, generated, or user-supplied, etc.) can also be displayed to the user in the final ranked list in order for the user to make a decision on which documents to view or explore, or to use as a basis for further chained discovery. For example, showing screenshots of the first page of a document, or an excerpt from a section of the document, may indicate to the user whether they should pursue the chains through which utilizing that document would allow the discovery.

Furthermore, in some cases, the document results can be truncated. For example, to avoid overwhelming the user, a threshold defining a maximum number of documents that are shown from a particular user's favorites. For example, if a user has identified 150 documents in total as being his or her favorites, when this user is discovered during the exploration process, only the ten most recently favorited documents can be displayed to aid in further chain traversal. Other criteria can be used to rank how many documents are displayed including, for example, creation date, last access date, last edit data, number of accesses, number of users favoriting the document, and the like.

In some variations, roles and authorizations of the user traversing the documents within the content management system 130 can be used to filter the documents as being a favorite. For example, a manager might not have authorization to review documents from a vice president, and as such, the traversal may terminate at the vice president. Similarly, documents that require a certain access level in order to review, edit, or access, can be excluded from the result lists for those users not having such access level.

Other types of filtering of the favorite documents can be implemented including, for example, providing an input box by which a user can enter one or more key words or enter a full text query. Thereafter, only documents matching such key words/query will be displayed. Such an arrangement can be helpful in that there can be cases in which some authors who have created and/or favorited many documents. In order to avoid getting stuck in a local minimum in an graph that models the connected favorites, the user can start with (or jump to) a different initial set of documents resulting from a keyword search/full text query. That is, documents can be filtered down to a set including at least one chained document associated with the keyword. For example, the document can include the keyword or a variant of the keyword via such techniques as word stemming, in an applied tag, a term extracted from within the document, and the like.

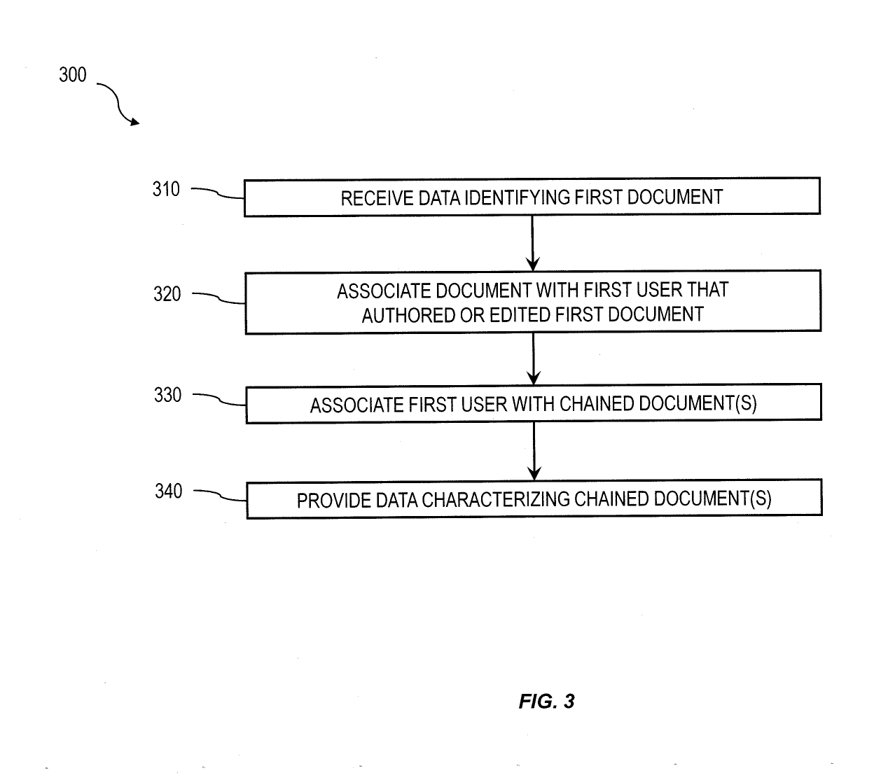

FIG. 3 is a process flow diagram illustrating a method 300 in which, at 310, data is received by a content management system that identifies a first document managed by the content management system. Thereafter, at 320, the content management system firstly associates the document with a first user that authored or edited the document. Next, at 330, the content management system secondly associates the first user with at least one chained document different from the first document. The at least one chained document has at least one pre-defined attribute associated with the first user (e.g., the document was indicated as being a favorite by the first user). Subsequently, at 340, data can be provided (e.g., displayed, transmitted, loaded, stored, etc.) that characterizes the at least one chained document.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving data, by a content management system, identifying a first document managed by the content management system;
first associating, by the content management system, the document with a first user that authored or edited the first document;
second associating, by the content management system, the first user with at least one chained document different from the first document, the at least one chained document has at least one pre-defined attribute associated with the first user; and
providing data characterizing the at least one chained document.

2. A method as in claim 1, wherein the at least one first attribute comprises the first user having indicated as being a favorite document.

3. A method as in claim 1, wherein the at least one first attribute is selected from a group consisting of: the first user accessed the chained document, the first user edited the chained document, and the first user generated the first document.

4. A method as in claim 1, wherein there are a plurality of chained documents and the chained documents are presented to a user according to a ranking.

5. A method as in claim 4, wherein the ranking is based on a time at which each document was indicated as being a favorite document for the first user.

6. A method as in claim 4, wherein the ranking is based on a time at which each document was generated.

7. A method as in claim 4, wherein the ranking is based on a time at which each document was last accessed.

8. A method as in claim 4, wherein the ranking is based on a number of times that each document was accessed.

9. A method as in claim 4, wherein the ranking is based on a time at which each document was last edited.

10. A method as in claim 1, further comprising:
receiving user-generated input specifying at least one keyword or search filter; and
filtering the at least one chained document to include only those documents associated with the at least one keyword or search filter.

11. A method as in claim 1, further comprising:
preventing access to documents for which the user does not have authorization to access.

12. A method as in claim 1, wherein the content management system comprises at least one data processor and at least one database for storing the plurality of documents.

13. A method as in claim 1, wherein providing data comprises one or more of: displaying the data, transmitting the data to a remote server, loading the data into memory, and storing the data.

14. A non-transitory computer program product storing instructions, which when executed by at least one data processor of at least one computing system, result in operations comprising:
receiving data, by a content management system, identifying a first document managed by the content management system;
first associating, by the content management system, the document with a first user that authored or edited the first document;
second associating, by the content management system, the first user with at least one chained document different from the first document, the at least one chained document has at least one pre-defined attribute associated with the first user; and
providing data characterizing the at least one chained document.

15. A computer program product as in claim 14, wherein the at least one first attribute comprises the first user having indicated as being a favorite document.

16. A computer program product as in claim 14, wherein the at least one first attribute is selected from a group consisting of: the first user accessed the chained document, the first user edited the chained document, and the first user generated the first document.

17. A computer program product as in claim 14, wherein there are a plurality of chained documents and the chained documents are presented to a user according to a ranking.

18. A computer program product as in claim 17, wherein the ranking is based on a factor selected from a group consisting of: a time at which each document was indicated as being a favorite document for the first user, a time at which each document was generated, a time at which each document was last accessed, a number of times that each document was accessed, a time at which each document was last edited.

19. A computer program product as in claim 14, further comprising:
receiving user-generated input specifying at least one keyword or search filter; and
filtering the at least one chained document to include only those documents associated with the at least one keyword or search filter.

20. A content management system comprising:
at least one data processor; and
memory storing instructions, which when executed by the at least one data, result in operations comprising:
receiving data identifying a first document managed by the content management system;
first associating the document with a first user that authored or edited the first document;
second associating the first user with at least one chained document different from the first document, the at least one chained document has at least one pre-defined attribute associated with the first user; and
providing data characterizing the at least one chained document.
